(19) United States
(12) Patent Application Publication
(10) Pub. No.: US 2026/0127721 A1
(43) Pub. Date: May 7, 2026

(54) METHOD, APPARATUS, DEVICE, AND MEDIUM OF IMAGE PROCESSING BASED ON EVENT CAMERA

(71) Applicant: The Hong Kong University of Science and Technology (Guangzhou), Guangzhou (CN)

(72) Inventors: Hui Xiong, Guangzhou (CN); Zipeng Wang, Guangzhou (CN); Yunfan Lu, Guangzhou (CN)

(21) Appl. No.: 19/367,796

(22) Filed: Oct. 23, 2025

(30) Foreign Application Priority Data
Nov. 4, 2024 (CN) 202411560346.7

(51) Int. Cl. G06T 5/70; G06T 5/50; G06T 5/60; G06T 5/92; G06T 7/90; H04N 25/47

(52) U.S. Cl. CPC G06T 5/70; G06T 5/50; G06T 5/60; G06T 5/92; G06T 7/90; H04N 25/47; G06T 2207/10024; G06T 2207/20081; G06T 2207/20084; G06T 2207/20208

(57) ABSTRACT

A method, an apparatus, a device, and a medium of image processing based on an event camera. The method obtains event data from blurred image captured by the event camera; constructs an initial PINN model, and embeds an event generation equation into the initial PINN model; inputs the event data into the PINN model to obtain a predicted luminance change-gradient value; performs self-supervised optimization using a temporal derivative loss based on the predicted luminance change-gradient value and a ground-truth luminance change-gradient value, and introduces a Tikhonov regularization constraint condition to optimize the PINN model; inputs the event data corresponding to a to-be-processed image into the optimized PINN model to obtain luminance values in logarithmic domain of three color channels of the to-be-processed image; and uses tone mapping to convert the luminance values in the logarithmic domain into reconstructed image frames.

### CROSS-REFERENCE TO RELATED APPLICATIONS

The present disclosure claims the benefit of Chinese patent application No. 202411560346.7 filed on Nov. 4, 2024, and entitled “Method, Apparatus, Device, and Medium of Image Processing Based on Event Camera”, which is hereby incorporated by reference in its entirety.

### TECHNICAL FIELD

The present disclosure relates to the field of image processing, and in particular to a method, an apparatus, a device, and a medium of image processing based on an event camera.

### BACKGROUND

With the continuous advancement of the technology of computer vision, traditional frame cameras encounter some challenges when processing dynamic scenes and high dynamic range (HDR) environments. To overcome these challenges, event cameras are developed as a new type of sensors, which are gradually concerned with the characteristics of low power consumption, high dynamic range, and high temporal resolution, and become a new hotspot in computer vision research. Unlike a traditional camera, the event camera can capture a brightness change in a scene at a temporal resolution of a microsecond level, generating sparse and asynchronous event stream data. Format of the event stream data differs significantly from that of traditional frame images, presenting a new challenge for information processing and algorithm design.

Existing event stream processing methods primarily depend on supervised learning, which requires a large amount of labeled data to train models. However, synthetic training data often differs from real scenes, resulting in degraded algorithm performance in practical applications. Additionally, the existing event stream processing or traditional frame-based methods often lack robustness to noise when processing complex illumination conditions and high dynamic range scenes, thereby affecting the quality of reconstruction results.

### SUMMARY

To this end, the present disclosure provides a method, an apparatus, a device, and a medium of image processing based on an event camera, which reduces dependence on labeled data, that is, high-quality reconstruction may be performed on a blurred image.

According to a first aspect, the present disclosure provides a method of image processing based on an event camera.

The present disclosure is implemented through following technical solution:

A method of image processing based on an event camera, including:
obtaining event data corresponding to a blurred image captured by the event camera;
constructing an initial Physics-Informed Neural Network (PINN) model, and embedding an event generation equation into the initial PINN model, where an input item of the initial PINN model is the event data, and an output item of the initial PINN model is a predicted luminance change-gradient value satisfying the event generation equation;
inputting the event data corresponding to the blurred image into the initial PINN model to obtain the predicted luminance change-gradient value of the event data, performing self-supervised optimization using a temporal derivative loss based on the predicted luminance change-gradient value and a ground-truth luminance change-gradient value, introducing a Tikhonov regularization constraint condition to optimize the initial PINN model, and determining an optimized PINN model in response to a predictive performance of the PINN model meeting a predefined standard;
inputting the event data corresponding to a to-be-processed image into the optimized PINN model to obtain luminance values in logarithmic domain of three color channels of the to-be-processed image; and
using tone mapping to convert the luminance values in the logarithmic domain of the three color channels into reconstructed image frames.

In a preferred example of the present disclosure, the using tone mapping to convert the luminance values in the logarithmic domain of the three color channels into reconstructed image frames includes:
converting the luminance values in the logarithmic domain of the three color channels into high dynamic range (HDR) luminance values through an exponential function;
adjusting luminance and contrast of the to-be-processed image through Reinhard tone-mapping function to convert the HDR luminance values into low dynamic range (LDR) luminance values; and
generating the reconstructed image frames based on the LDR luminance values.

In a preferred example of the present disclosure, the inputting the event data corresponding to a to-be-processed image into the optimized PINN model to obtain luminance values in logarithmic domain of three color channels of the to-be-processed image includes:
inputting time coordinates of the event data into the optimized PINN model to obtain the luminance values in the logarithmic domain of a red channel, a green channel, and a blue channel.

In a preferred example of the present disclosure, hidden layers of the PINN model are multi-layer fully connected neural networks, and parameters of the initial PINN model are randomized.

In a preferred example of the present disclosure, the performing self-supervised optimization using a temporal derivative loss based on the predicted luminance change-gradient value and a ground-truth luminance change-gradient value includes:
calculating a luminance change-gradient difference between the predicted luminance change-gradient value output by the PINN model and the ground-truth luminance change-gradient value calculated by the event generation equation; and
determining a mean square error loss function based on the luminance change-gradient difference, and performing the self-supervised optimization using the temporal derivative loss of the PINN model based on the mean square error loss function.

In a preferred example of the present disclosure, the introducing a Tikhonov regularization constraint condition to optimize the initial PINN model includes:
constraining a spatial gradient of the luminance in the logarithmic domain through the Tikhonov regularization, expressed as:

$${L}_{reg} = {( \frac{\partial {F}_{Θ}}{\partial x} )}^{2} + {( \frac{\partial {F}_{Θ}}{\partial y} )}^{2} ,$$

where, L_{reg} represents a regularization constraint condition,

$$\frac{\partial {F}_{Θ}}{\partial x}$$

represents a derivative of a trained PINN network F_{Θ} in an x dimension, and

$$\frac{\partial {F}_{Θ}}{\partial y}$$

represents a derivative of the trained PINN network F_{Θ} in a y dimension.

In a preferred example of the present disclosure,
the event generation equation is expressed as:

$$\frac{\partial L ( \frac{{t}_{1} + {t}_{2}}{2} )}{\partial t} = \frac{1}{{t}_{2} - {t}_{1}} {\int }_{{t}_{1}}^{{t}_{2}} {\sum }_{i} {P}_{i} θ δ ( t - {t}_{i} ) dt ,$$

where L represents a luminance change-gradient function, Pᵢ represents a direction of luminance change-gradient, θ represents a luminance change-gradient threshold that triggers an event, δ(t-tᵢ) represents a Dirac delta function, and t₁ and t₂ represent the time coordinates.

According to a second aspect, the present disclosure provides an apparatus of image processing based on the event camera.

The present disclosure is implemented through following technical solution:

An apparatus of image processing based on the event camera, which is configured to perform the method of image processing based on the event camera described in the first aspect above, where the apparatus of image processing includes:
a data obtaining module, configured to obtain the event data corresponding to the blurred image captured by the event camera;
a model construction module, configured to construct the initial PINN model, and embed the event generation equation into the initial PINN model, where the input item of the initial PINN model is the event data, and the output item of the initial PINN model is the predicted luminance change-gradient value satisfying the event generation equation;
a model optimization module, configured to input the event data corresponding to the blurred image into the initial PINN model to obtain the predicted luminance change-gradient value of the event data, perform the self-supervised optimization using the temporal derivative loss based on the predicted luminance change-gradient value and the ground-truth luminance change-gradient value, introduce the Tikhonov regularization constraint condition to optimize the initial PINN model, and determine the optimized PINN model in response to the predictive performance of the PINN model meets the predefined standard;
a luminance value prediction module, configured to input the event data corresponding to the to-be-processed image into the optimized PINN model to obtain the luminance values in the logarithmic domain of the three color channels of the to-be-processed image; and
a tone mapping module, configured to use tone mapping to convert the luminance values in the logarithmic domain of the three color channels into the reconstructed image frames.

According to a third aspect, the present disclosure is implemented through following technical solution:

A computer device, including a memory, a processor, and a computer program stored in the memory and executable on the processor, where any one of steps of the method of image processing based on the event camera is performed by the processor when the processor executes the computer program.

According to a fourth aspect, the present disclosure provides a non-transitory computer-readable storage medium.

The present disclosure is implemented through following technical solution:

A non-transitory computer-readable storage medium, where the non-transitory computer-readable storage medium stores a computer program, and the computer program, when executed by the processor, performs any one of the steps of the method of image processing based on the event camera.

In summary, compared with the prior art, beneficial effects of the technical solution provided in the examples of the present disclosure at least include:

In the present disclosure, the event data corresponding to the blurred image captured by the event camera is obtained; the initial PINN model is constructed and the event generation equation is embedded into the initial PINN model; the event data corresponding to the blurred image is input into the initial PINN model to obtain the predicted luminance change-gradient value of the event data, the self-supervised optimization using the temporal derivative loss based on the predicted luminance change-gradient value and the ground-truth luminance change-gradient value is performed, and the Tikhonov regularization constraint condition is introduced to optimize the initial PINN model, and the optimized PINN model is determined when the predictive performance of the PINN model meets the predefined standard; the event data corresponding to the to-be-processed image is input into the optimized PINN model to obtain the luminance values in the logarithmic domain of the three color channels of the to-be-processed image; and the tone mapping is configured to convert the luminance values in the logarithmic domain of the three color channels into the reconstructed image frames. In the present disclosure, the PINN model is configured to solve approximate solutions of physical equations in an event generation model through self-supervised learning, which reduces a dependence on a large amount of labeled data, thereby significantly reducing a cost and time investment in data labeling and improving an applicability of the model in a real scene; and dual constraint conditions of the self-supervised optimization using the temporal derivative loss and spatial regularization are used to reduce a prediction error of the model, reduce noise and artifacts in a reconstructed image, and improve quality of the reconstructed image reconstructed by the model.

### BRIEF DESCRIPTION OF THE DRAWINGS

FIG. 1 is a schematic flowchart of a method of image processing based on an event camera according to an embodiment of the present disclosure;

FIG. 2 is a schematic structural diagram of an apparatus of image processing based on an event camera according to an embodiment of the present disclosure;

### BRIEF DESCRIPTION OF REFERENCE NUMERALS

data obtaining module 101, model construction module 201, model optimization module 301, luminance value prediction module 401, and tone mapping module 501.

### DETAILED DESCRIPTION

The embodiments are merely an explanation of the present disclosure and are not intended to limit the present disclosure, and a person skilled in the art may make modifications to the embodiments without involving inventive steps according to needs after reading the present specification, provided that such modifications remain within the scope of the claims of the present disclosure and are thus protected by patent law.

In order to make the objectives, technical solutions, and advantages of the embodiments of the present disclosure clearer, the following clearly and completely describes the technical solutions in the embodiments of the present disclosure with reference to the accompanying drawings in the embodiments of the present disclosure. It should be noted that the described embodiments are only part of the embodiments of the present disclosure and not all of them. All other embodiments obtained by a person of ordinary skill in the art based on the embodiments of the present disclosure without creative efforts shall fall within the protection scope of the present disclosure.

In addition, the term “and/or” in the present disclosure is merely a description of the relationship between associated objects, indicating that there may be three relationships, for example, A and/or B may indicate that A exists alone, A and B exist at the same time, and B exists alone. Additionally, the character “/” in the present disclosure generally indicates an “or” relationship between the associated objects unless otherwise specified.

The terms such as “first” and “second” in the present disclosure are used to distinguish between identical or similar items with essentially the same functions or effects, and it should be understood that there is no logic or temporal dependency between “first”, “second” and “nth”, nor do these terms impose any limitations on quantity or execution order.

The following description further details the embodiments of the present disclosure reference to the accompanying drawings. A method of image processing based on an event camera of the present disclosure may be applied in various application scenes, including low-light image enhancement for autonomous driving, image stabilization, and efficient compression of video data.

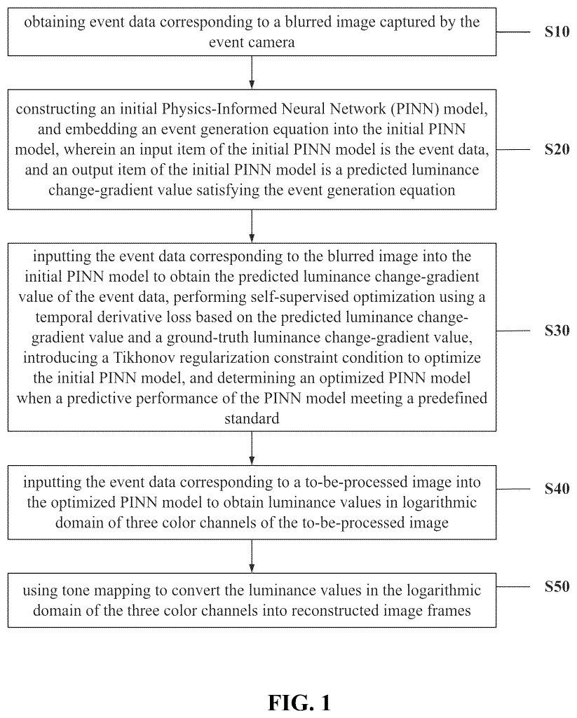

As shown in FIG. 1, a method of image processing based on an event camera provided in the present disclosure includes:

S10: obtaining event data corresponding to a blurred image captured by the event camera.

The event camera is a new type of visual sensor and is different from a traditional camera continuously capturing images, each pixel in the event camera is an independent sensor that may respond to changes in luminance signals. When a luminance change-gradient of the pixel exceeds a preset threshold, an event is triggered, generating a series of sparse and asynchronous event sequences (also known as event stream). The event camera outputs data asynchronously in a unit of the event without waiting for an entire frame to be captured and transmitted, and thus has extremely low latency. In practical implementation, any of the following event cameras may be used: DAVIS346, DVXplorer, PROPHESEE Metavision EVK4, or PROPHESEE Metavision EVK5. Each event in the event sequences is represented as: (x₁,yᵢ,t₁,P₁), where xᵢ represents a horizontal coordinate of the pixel for a current event i, yᵢ represents a vertical coordinate of the pixel for the current event i, tᵢ represents a time coordinate corresponding to the current event i, Pᵢ represents a direction of the luminance change-gradient (also known as polarity) of the pixel for the current event i, indicating whether the luminance increases or decreases. The value of Pᵢ may be −1 or +1; when P₁ is −1, it indicates a decrease in the luminance of the pixel; when P₁ is +1, it indicates an increase of the luminance of the pixel.

S20: constructing an initial Physics-Informed Neural Network (PINN) model, and embedding an event generation equation into the initial PINN model, where an input item of the initial PINN model is the event data, and an output item of the initial PINN model is a predicted luminance change-gradient value satisfying the event generation equation.

First, in the present disclosure, the initial PINN (Physics-Informed Neural Network) model is constructed. The PINN model takes the event data, specifically a timestamp (i.e., time coordinate) of the current event of the input event data, as an input; and the PINN model takes the predicted luminance change-gradient value of three color channels corresponding to the pixel of the current event as an output, the predicted luminance change-gradient value of three color channels are specifically the predicted luminance change-gradient value of a red channel, the predicted luminance change-gradient value of a green channel, and the predicted luminance change-gradient value of a blue channel. A structure of the PINN model includes an input layer, hidden layers, and an output layer. The hidden layers are multi-layer fully connected neural networks composed of a plurality of layers, each of which includes a plurality of neurons. In constructing the initial PINN model, parameters of the initial PINN model are randomized. Subsequently, in a training process, the parameters of the PINN model are optimized and adjusted.

In some embodiments, in order to simplify the analysis, in the present disclosure, the luminance change-gradient of a single pixel is assumed under a fixed spatial coordinate system, that is, ignoring a change in a position of the pixel of the image and focusing only on a luminance value of each pixel. The luminance of each pixel may be changed, and different luminance of the pixel represent different colors. The Dirac delta function δ may be used to describe the event eᵢ on the pixel in the event data: eᵢ=Pᵢθδ(t-tᵢ), θ represents a luminance change-gradient threshold that triggers the event;

A luminance change-gradient value may be represented by an accumulation of the event on the pixel in a preset time interval [t₁,t₂]:

$$Δ L = L ( {t}_{2} ) - L ( {t}_{1} ) ,$$

$$Δ L = {\int }_{{t}_{1}}^{{t}_{2}} {e}_{i} ( t ) dt ,$$

Assuming the time interval [t₁,t₂] is short and noise may be neglected, a non-linear luminance change-gradient may be converted, using a Taylor expansion, into a linear luminance change-gradient, i.e., a first-order time derivative of the luminance change-gradient value, which represents a rate of change of the luminance over time in logarithmic domain:

$$\frac{Δ L}{{t}_{2} - {t}_{1}} = \frac{\partial L ( ( {t}_{1} + {t}_{2} ) / 2 )}{\partial t} ,$$

The event generation equation may then be expressed as:

$$\frac{\partial L ( \frac{{t}_{1} + {t}_{2}}{2} )}{\partial t} = \frac{1}{{t}_{2 -} {t}_{1}} {\int }_{{t}_{1}}^{{t}_{2}} {\sum }_{i} {P}_{i} θ δ ( t - {t}_{i} ) dt ,$$

where L represents a luminance change-gradient function, Pᵢ represents the direction of the luminance change-gradient, θ represents the luminance change-gradient threshold that triggers the event, δ(t-t₁) represents the Dirac delta function, and t₁ and t₂ represent the time coordinates.

The event generation equation is embedded into the PINN model, and is used as a physical constraint when the PINN model processes the event data, ensuring that the output of the PINN model satisfies a constraint condition of the physical equation (i.e., event generation equation).

When constructing the initial PINN model, parameters of the initial PINN model are randomized. The PINN model represents complex information through a parameterized fully connected multilayer perceptron (MLP). By integrating the aforementioned event generation equation into the training process of the neural network, the learning of the neural network is guided, enabling effective training and prediction even if data is scarce or noise is large.

S30: inputting the event data corresponding to the blurred image into the initial PINN model to obtain a predicted luminance change-gradient value of the event data, performing self-supervised optimization using a temporal derivative loss based on the predicted luminance change-gradient value and a ground-truth luminance change-gradient value, introducing a Tikhonov regularization constraint condition to optimize the initial PINN model, and determining an optimized PINN model when a predictive performance of the PINN model meeting a predefined standard.

In some embodiments, a luminance change-gradient difference between the predicted luminance change-gradient value Δ\hat{L} output by the PINN model and the ground-truth luminance change-gradient value ΔL calculated by the event generation equation is directly minimized:

$$Δ \hat{L} = \frac{\partial {F}_{Θ} ( ( {t}_{1} + {t}_{2} ) / 2 )}{\partial t} \times ( {t}_{{2}^{-}} {t}_{1} ) ,$$

$$Δ L = \frac{\partial L ( ( {t}_{1} + {t}_{2} ) / 2 )}{\partial t} \times ( {t}_{{2}^{-}} {t}_{1} ) ,$$

A mean square error loss function is determined based on the luminance change-gradient difference, and the self-supervised optimization using the temporal derivative loss of the PINN model is performed based on the mean square error loss function:

$${L}_{temp} = {( Δ L - Δ \hat{L} )}^{2} .$$

Where, Lₜₑₘₚ is a mean squared error (MSE) representing the luminance change-gradient difference between the predicted luminance change-gradient value and a corresponding ground-truth luminance change-gradient value.

Although the self-supervised optimization using the temporal derivative loss may estimate the luminance change-gradient function L(t), considering that there is no prior knowledge for an initial luminance value of each pixel in the PINN model, in order to eliminate unrealistic textures such as artifacts that may be included in an estimated result of the luminance change-gradient function, the present disclosure further introduces the Tikhonov regularization constraint condition into the loss function to make a model output result more realistic. Specific steps are as follows:

A spatial gradient of the luminance in the logarithmic domain is constrained by Tikhonov regularization, expressed as:

$${L}_{reg} = {( \frac{\partial {F}_{Θ}}{\partial x} )}^{2} + {( \frac{\partial {F}_{Θ}}{\partial y} )}^{2} ,$$

where, L_{reg} represents a regularization constraint condition,

$$\frac{\partial {F}_{Θ}}{\partial x}$$

represents a derivative of a trained PINN network Fe in the x dimension,

$$\frac{\partial {F}_{Θ}}{\partial y}$$

represents a derivative of the trained PINN network F_{Θ} in the y dimension, and F_{Θ} represents the trained PINN network.

The Tikhonov regularization limits complexity of the model by penalizing large parameter changes, which helps the model perform well on unknown data, thereby reducing a risk of overfitting. Compared to some complex regularization methods, such as a Convolutional Neural Networks (CNN) denoiser, the Tikhonov regularization is simpler and more efficient in computation, does not need a large-scale network model, and thus significantly reduces training time.

An overall objective function for the PINN model during the training process is: L=Lₜₑₘₚ+λL_{reg}, the PINN model is trained through gradient descent based on the objective function. When a value of the objective function decreases to a preset threshold (e.g., 1e-6), or when the value of the objective function no longer decreases significantly after training to certain epochs (e.g., the output value of the objective function does not decrease by more than 3% over 10 consecutive epochs), the model is considered to have converged, and the predictive performance of the PINN model has met the predefined standard, so training may be ended.

S40: inputting event data corresponding to a to-be-processed image into the optimized PINN model to obtain luminance values in the logarithmic domain of the three color channels of the to-be-processed image.

The event data corresponding to the to-be-processed image is input into the optimized PINN model. The PINN model predicts the luminance values of the three color channels (red channel, green channel, and blue channel) based on the time coordinate t of the event data. The PINN model constructed in the present disclosure is not limited to luminance prediction for a single color channel, for example, the luminance prediction for a single red, green, or blue channel, but can be extended to the luminance prediction for the three color channels (RGB: Red, Green, and Blue).

S50: using tone mapping to convert the luminance values in the logarithmic domain of the three color channels into reconstructed image frames.

Specifically, the luminance values in the logarithmic domain of the three color channels are converted into HDR (i.e., high dynamic range) luminance values through an exponential function:

$$I ( x , y , t ) = exp ( {F}_{Θ} ( x , y , t ) ) ;$$

Luminance and contrast of the to-be-processed image are adjusted through Reinhard tone-mapping function to convert the HDR luminance values in the logarithmic domain into low dynamic range (LDR) luminance values in the logarithmic domain, and the specific expression is:

$$Γ ( I ) = {( \frac{I}{I + 1} )}^{γ} ,$$

I represents the HDR luminance values in the logarithmic domain, Γ(I) represents the LDR luminance values in the logarithmic domain, and y represents a hyper-parameter used to control the contrast;

Then the reconstructed image frames are generated based on the LDR luminance values.

In some feasible embodiments, the event camera is mounted on an autonomous vehicle, and a position of the event camera is adjusted to a front of the autonomous vehicle to more accurately obtain images captured by the event camera in a driving process of the autonomous vehicle. In a night driving process, the event camera captures event data in low-light environments, and the event data includes luminance change-gradient information of a road, a pedestrian, and a vehicle in the night driving process. First, the event data is input into the Physics-Informed Neural Network model (PINN model) as input data. The PINN model performs feature extraction on the event data, and the PINN model is optimized through the self-supervised optimization using the temporal derivative loss and spatial regularization constraint condition (including the Tikhonov regularization constraint condition), so as to minimize the mean square error between a predicted luminance change-gradient and an actual event data, while reducing noise and artifacts in a reconstructed image. The optimized PINN model is used for low-light image enhancement processing to generate high-quality image frames. The tone mapping is configured to convert a HDR luminance value into LDR image frames. Image definition and luminance are significantly enhanced in the night driving process, enabling accurate identification of roads, pedestrians, and other vehicles, thereby improving a perception capability and security of an autonomous driving system in the low-light environments.

In some embodiments, the method of image processing of the present disclosure is applicable to image processing when shooting a dynamic scene, which is possible to remove image blur caused by camera shake, and generate a clear image frame. Through a data collection software or an interface of the event camera, the event data recording jitter and blur is obtained, and the event data includes temporal and spatial information of the luminance change-gradient on the pixel. The information of the event data is used as an input for the PINN model, which is optimized through the self-supervised optimization using the temporal derivative loss and the spatial regularization. The self-supervised optimization using the temporal derivative loss is used to minimize the mean square error between the predicted luminance change-gradient and the actual event data, while the spatial regularization is used to reduce the noise and the artifacts in the reconstructed image. The optimized PINN model is then used for stabilization processing to generate clear image frames. The tone mapping is configured to convert HDR luminance values to LDR image frames. The jitter and blurring are removed from the image, and the generated image frame is clearer, the method is suitable for high-quality image processing in a dynamic scene, and detail retention and visual effects of the image are improved.

In some embodiments, the method of image processing of the present disclosure is applicable to a scene of efficient compression of video data, reducing bandwidth required for storage and transmission while maintaining high-quality video reconstruction. Event data corresponding to video captured by the event camera is obtained through the data collection software or the interface of the event camera. The event data corresponding to video records luminance change-gradient information in video frames. Information of the event data is input into the PINN model as an input, and the PINN model is optimized through the self-supervised optimization using the temporal derivative loss and the spatial regularization. The self-supervised optimization using the temporal derivative loss is used to minimize the mean square error between the predicted luminance change-gradient and the actual event data, while the Tikhonov regularization is used to reduce the noise and the artifacts in the reconstructed image. Compressed representation is performed on the video data through the optimized PINN model, and luminance information in the video frames are converted into parameters of the PINN model, thereby achieving efficient compression. Through decompression, the compressed representation is restored to high-quality video frames. The tone mapping is configured to convert HDR luminance values into LDR image frames. High-compression-rate video compression is achieved, meanwhile, high-quality image reconstruction is maintained, the bandwidth and storage space required for video storage and transmission are significantly reduced, and economy and practicability of video application are improved.

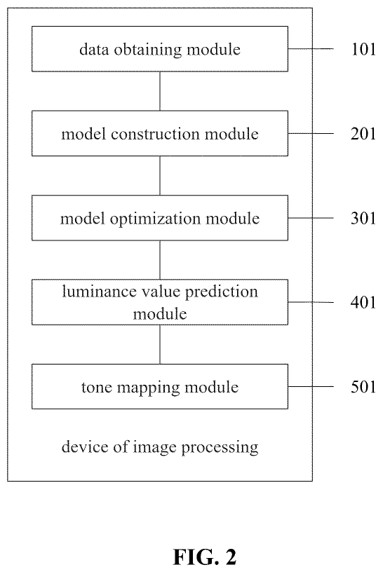

Another embodiment of the present disclosure further provides an apparatus of image processing based on the event camera, where the apparatus is configured to perform the method of image processing based on the event camera mentioned above. As shown in FIG. 2, the apparatus includes:
a data obtaining module 101, configured to obtain the event data corresponding to the blurred image captured by the event camera; in an embodiment, the data obtaining module 101 may be an event camera, such as DAVIS346 (iniVation AG), DVXplorer (iniVation AG), PROPHESEE Metavision EVK4, or PROPHESEE Metavision EVK5 (Prophesee S.A.).
a model construction module 201, configured to construct the initial PINN model, and embed the event generation equation into the initial PINN model, where the input item of the initial PINN model is the event data, and the output item of the initial PINN model is the predicted luminance change-gradient value satisfying the event generation equation;
a model optimization module 301, configured to input the event data corresponding to the blurred image into the initial PINN model to obtain the predicted luminance change-gradient value of the event data, perform self-supervised optimization using the temporal derivative loss based on the predicted luminance change-gradient value and the ground-truth luminance change-gradient value, introduce the Tikhonov regularization constraint condition to optimize the initial PINN model, and determine the optimized PINN model when the predictive performance of the PINN model meets the predefined standard;
a luminance value prediction module 401, configured to input the event data corresponding to the to-be-processed image into the optimized PINN model to obtain the luminance values in the logarithmic domain of the three color channels of the to-be-processed image;
a tone mapping module 501, configured to use tone mapping to convert the luminance values in the logarithmic domain of the three color channels into the reconstructed image frames; and
a processor, configured to execute following program modules stored in a memory: the model construction module 201, the model optimization module 301, the luminance value prediction module 401, and the tone mapping module 501.

In some embodiments, the tone mapping module 501 is configured to convert the luminance values in the logarithmic domain of the three color channels into the HDR luminance values through an exponential function: I(x,y,t)=exp(F_{Θ}(x,y,t));

Luminance and contrast of the to-be-processed image are adjusted through Reinhard tone-mapping function to convert the HDR luminance values in the logarithmic domain into LDR luminance values in the logarithmic domain, and the specific expression is:

$$Γ ( I ) = {( \frac{I}{I + 1} )}^{γ} ,$$

where I represents the HDR luminance values in the logarithmic domain, Γ(j) represents the LDR luminance values in the logarithmic domain, and y represents the hyper-parameter used to control the contrast.

For a specific definition of the apparatus of image processing based on the event camera provided in this embodiment, reference may be made to the embodiment of the method of image processing based on the event camera described above, and details are not described herein again. All or some of the modules in the apparatus of image processing based on the event camera described above may be implemented through software, hardware, or a combination thereof. The above-mentioned modules may be embedded in or independent of the processor in a computer device in a form of hardware, or may be stored in the memory of the computer device in a form of software, so that the processor may call and execute operations corresponding to each of the above-mentioned modules.

An embodiment of the present disclosure provides a computer device, and the computer device may include a processor, a memory, a network interface, and a database that are connected through a system bus. Where, the processor of the computer device is configured to provide computing and control capabilities. The memory of the computer device includes a non-transitory storage medium and an internal memory. The non-transitory storage medium stores an operating system, a computer program, and a database. The internal memory provides an environment for an operation of the operating system and the computer program stored in the non-transitory storage medium. The network interface of the computer device is configured to communicate with an external terminal through a network connection. When the computer program is executed by the processor, the processor performs the steps of the method of image processing based on the event camera according to any of the above embodiments.

A working process, working details, and technical effects of the computer device provided in this embodiment may refer to the above embodiments of the method of image processing based on the event camera, and details are not described herein again.

An embodiment of the present disclosure provides a non-transitory computer-readable storage medium on which the computer program is stored, and the computer program, when executed by the processor, implements the steps of the method of image processing based on the event camera according to any of the above embodiments. The non-transitory computer-readable storage medium refers to a data storage medium, which may include but is not limited to a floppy disk, an optical disk, a hard disk, a flash memory, a USB flash disk, and/or a memory stick, among others. The computer may be a general-purpose computer, a special-purpose computer, a computer network, or other programmable devices.

A working process, working details, and technical effects of the non-transitory computer-readable storage medium provided in this embodiment may refer to the above embodiments of the method of image processing based on the event camera, and details are not described herein again.

A person of ordinary skill in the art may understand that all or some of the processes in the methods of the above embodiments may be implemented by instructing related hardware through the computer program. The computer program may be stored in the non-transitory computer-readable storage medium, and when executed, may include the processes of the embodiments of the above methods. Any reference to the memory, the storage, the database, or other media in the embodiments provided in the present disclosure may include non-transitory and/or transitory memory. The non-transitory memory may include a read-only memory (ROM), a programmable ROM (PROM), an electrically programmable ROM (EPROM), an electrically erasable programmable ROM (EEPROM), or a flash memory. The transitory memory may include random access memory (RAM) or external high-speed cache memory. By way of illustration and not limitation, RAM is available in various forms, such as static RAM (SRAM), dynamic RAM (DRAM), synchronous DRAM (SDRAM), double data rate SDRAM (DDRSDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM), among others.

The technical features of the above embodiments may be combined in any manner. For the sake of brevity, not all possible combinations of the technical features in the above embodiments are described. However, as long as there is no contradiction between the combinations of these technical features, they should be considered to be within the scope of the present specification.

It may be clearly understood by a person skilled in the art that, for the sake of convenience and brevity of description, the division of the above-mentioned functional units and modules is merely used for illustration. In practical applications, the above-mentioned functions may be allocated to different functional units and modules according to needs, that is, the internal structure of the system described in the present disclosure may be divided into different functional units or modules to complete all or part of the functions described above.

1. A method of image processing based on an event camera, comprising:
obtaining event data corresponding to a blurred image captured by the event camera;
constructing an initial Physics-Informed Neural Network (PINN) model, and embedding an event generation equation into the initial PINN model, wherein an input item of the initial PINN model is the event data, and an output item of the initial PINN model is a predicted luminance change-gradient value satisfying the event generation equation;
inputting the event data corresponding to the blurred image into the initial PINN model to obtain the predicted luminance change-gradient value of the event data, performing self-supervised optimization using a temporal derivative loss based on the predicted luminance change-gradient value and a ground-truth luminance change-gradient value, introducing a Tikhonov regularization constraint condition to optimize the initial PINN model, and determining an optimized PINN model in response to a predictive performance of the PINN model meeting a predefined standard;
inputting the event data corresponding to a to-be-processed image into the optimized PINN model to obtain luminance values in logarithmic domain of three color channels of the to-be-processed image; and
using tone mapping to convert the luminance values in the logarithmic domain of the three color channels into reconstructed image frames.

2. The method of image processing based on the event camera according to claim 1, wherein the using tone mapping to convert the luminance values in the logarithmic domain of the three color channels into reconstructed image frames comprises:
converting the luminance values in the logarithmic domain of the three color channels into high dynamic range (HDR) luminance values through an exponential function;
adjusting luminance and contrast of the to-be-processed image through Reinhard tone-mapping function to convert the HDR luminance values into (LDR) luminance values; and
generating the reconstructed image frames based on the LDR luminance values.

3. The method of image processing based on the event camera according to claim 1, wherein the inputting the event data corresponding to a to-be-processed image into the optimized PINN model to obtain luminance values in logarithmic domain of three color channels of the to-be-processed image comprises:
inputting time coordinates of the event data into the optimized PINN model to obtain the luminance values in the logarithmic domain of a red channel, a green channel, and a blue channel.

4. The method of image processing based on the event camera according to claim 1, wherein hidden layers of the PINN model are multi-layer fully connected neural networks, and parameters of the initial PINN model are randomized.

5. The method of image processing based on the event camera according to claim 1, wherein the performing self-supervised optimization using a temporal derivative loss based on the predicted luminance change-gradient value and a ground-truth luminance change-gradient value comprises:
calculating a luminance change-gradient difference between the predicted luminance change-gradient value output by the PINN model and the ground-truth luminance change-gradient value calculated by the event generation equation; and
determining a mean square error loss function based on the luminance change-gradient difference, and performing the self-supervised optimization using the temporal derivative loss of the PINN model based on the mean square error loss function.

6. The method of image processing based on the event camera according to claim 4, wherein the introducing a Tikhonov regularization constraint condition to optimize the initial PINN model comprises:
constraining a spatial gradient of a luminance in the logarithmic domain through the Tikhonov regularization, expressed as:
$${L}_{reg} = {( \frac{\partial {F}_{Θ}}{\partial x} )}^{2} + {( \frac{\partial {F}_{Θ}}{\partial y} )}^{2} ,$$
wherein, L_{reg} represents a regularization constraint condition,
$$\frac{\partial {F}_{Θ}}{\partial x}$$
represents a derivative of a trained PINN network F_{Θ} in an x dimension, and
$$\frac{\partial {F}_{Θ}}{\partial y}$$
represents a derivative of the trained PINN network F_{Θ} in a y dimension.

7. The method of image processing based on the event camera according to claim 1, wherein the event generation equation is expressed as:
$$\frac{\partial L ( \frac{{t}_{1} + {t}_{2}}{2} )}{\partial t} = \frac{1}{{t}_{2} - {t}_{1}} {\int }_{{t}_{1}}^{{t}_{2}} {\sum }_{i} {P}_{i} θ δ ( t - {t}_{i} ) dt ,$$
wherein, L represents a luminance change-gradient function, Pᵢ represents a direction of luminance change-gradient, θ represents a luminance change-gradient threshold that triggers an event, δ(t-tᵢ) represents a Dirac delta function, and t₁ and t₂ represent time coordinates.

8. The method of image processing based on the event camera according to claim 2, wherein the event generation equation is expressed as:
$$\frac{\partial L ( \frac{{t}_{1} + {t}_{2}}{2} )}{\partial t} = \frac{1}{{t}_{2} - {t}_{1}} {\int }_{{t}_{1}}^{{t}_{2}} {\sum }_{i} {P}_{i} θ δ ( t - {t}_{i} ) dt ,$$
wherein, L represents a luminance change-gradient function, Pᵢ represents a direction of luminance change-gradient, θ represents a luminance change-gradient threshold that triggers an event, δ(t-tᵢ) represents a Dirac delta function, and t₁ and t₂ represent time coordinates.

9. The method of image processing based on the event camera according to claim 3, wherein the event generation equation is expressed as:
$$\frac{\partial L ( \frac{{t}_{1} + {t}_{2}}{2} )}{\partial t} = \frac{1}{{t}_{2} - {t}_{1}} {\int }_{{t}_{1}}^{{t}_{2}} {\sum }_{i} {P}_{i} θ δ ( t - {t}_{i} ) dt ,$$
wherein, L represents a luminance change-gradient function, Pᵢ represents a direction of luminance change-gradient, θ represents a luminance change-gradient threshold that triggers an event, δ(t-tᵢ) represents a Dirac delta function, and t₁ and t₂ represent time coordinates.

10. The method of image processing based on the event camera according to claim 4, wherein the event generation equation is expressed as:
$$\frac{\partial L ( \frac{{t}_{1} + {t}_{2}}{2} )}{\partial t} = \frac{1}{{t}_{2} - {t}_{1}} {\int }_{{t}_{1}}^{{t}_{2}} {\sum }_{i} {P}_{i} θ δ ( t - {t}_{i} ) dt ,$$
wherein, L represents a luminance change-gradient function, Pᵢ represents a direction of luminance change-gradient, θ represents a luminance change-gradient threshold that triggers an event, δ(t-tᵢ) represents a Dirac delta function, and t₁ and t₂ represent time coordinates.

11. The method of image processing based on the event camera according to claim 5, wherein the event generation equation is expressed as:
$$\frac{\partial L ( \frac{{t}_{1} + {t}_{2}}{2} )}{\partial t} = \frac{1}{{t}_{2} - {t}_{1}} {\int }_{{t}_{1}}^{{t}_{2}} {\sum }_{i} {P}_{i} θ δ ( t - {t}_{i} ) dt ,$$
wherein, L represents a luminance change-gradient function, Pᵢ represents a direction of luminance change-gradient, θ represents a luminance change-gradient threshold that triggers an event, δ(t-tᵢ) represents a Dirac delta function, and t₁ and t₂ represent time coordinates.

12. The method of image processing based on the event camera according to claim 6, wherein the event generation equation is expressed as:
$$\frac{\partial L ( \frac{{t}_{1} + {t}_{2}}{2} )}{\partial t} = \frac{1}{{t}_{2} - {t}_{1}} {\int }_{{t}_{1}}^{{t}_{2}} {\sum }_{i} {P}_{i} θ δ ( t - {t}_{i} ) dt ,$$
wherein, L represents a luminance change-gradient function, Pᵢ represents a direction of luminance change-gradient, θ represents a luminance change-gradient threshold that triggers an event, δ(t-tᵢ) represents a Dirac delta function, and t₁ and t₂ represent time coordinates.

13. An apparatus of image processing based on an event camera, configured to perform the method of image processing based on the event camera described in claim 1, comprising:
a data obtaining module, configured to obtain the event data corresponding to the blurred image captured by the event camera;
a model construction module, configured to construct the initial PINN model, and embed the event generation equation into the initial PINN model, wherein the input item of the initial PINN model is the event data, and the output item of the initial PINN model is the predicted luminance change-gradient value satisfying the event generation equation;
a model optimization module, configured to input the event data corresponding to the blurred image into the initial PINN model to obtain the predicted luminance change-gradient value of the event data, perform the self-supervised optimization using the temporal derivative loss based on the predicted luminance change-gradient value and the ground-truth luminance change-gradient value, introduce the Tikhonov regularization constraint condition to optimize the initial PINN model, and determine the optimized PINN model in response to the predictive performance of the PINN model meets the predefined standard;
a luminance value prediction module, configured to input the event data corresponding to the to-be-processed image into the optimized PINN model to obtain the luminance values in the logarithmic domain of the three color channels of the to-be-processed image; and
a tone mapping module, configured to use tone mapping to convert the luminance values in the logarithmic domain of the three color channels into the reconstructed image frames.

14. An apparatus of image processing based on an event camera, configured to perform the method of image processing based on the event camera described in claim 2, comprising:
a data obtaining module, configured to obtain the event data corresponding to the blurred image captured by the event camera;
a model construction module, configured to construct the initial PINN model, and embed the event generation equation into the initial PINN model, wherein the input item of the initial PINN model is the event data, and the output item of the initial PINN model is the predicted luminance change-gradient value satisfying the event generation equation;
a model optimization module, configured to input the event data corresponding to the blurred image into the initial PINN model to obtain the predicted luminance change-gradient value of the event data, perform the self-supervised optimization using the temporal derivative loss based on the predicted luminance change-gradient value and the ground-truth luminance change-gradient value, introduce the Tikhonov regularization constraint condition to optimize the initial PINN model, and determine the optimized PINN model in response to the predictive performance of the PINN model meets the predefined standard;
a luminance value prediction module, configured to input the event data corresponding to the to-be-processed image into the optimized PINN model to obtain the luminance values in the logarithmic domain of the three color channels of the to-be-processed image; and
a tone mapping module, configured to use tone mapping to convert the luminance values in the logarithmic domain of the three color channels into the reconstructed image frames.

15. An apparatus of image processing based on an event camera, configured to perform the method of image processing based on the event camera described in claim 3, comprising:
a data obtaining module, configured to obtain the event data corresponding to the blurred image captured by the event camera;
a model construction module, configured to construct the initial PINN model, and embed the event generation equation into the initial PINN model, wherein the input item of the initial PINN model is the event data, and the output item of the initial PINN model is the predicted luminance change-gradient value satisfying the event generation equation;
a model optimization module, configured to input the event data corresponding to the blurred image into the initial PINN model to obtain the predicted luminance change-gradient value of the event data, perform the self-supervised optimization using the temporal derivative loss based on the predicted luminance change-gradient value and the ground-truth luminance change-gradient value, introduce the Tikhonov regularization constraint condition to optimize the initial PINN model, and determine the optimized PINN model in response to the predictive performance of the PINN model meets the predefined standard;
a luminance value prediction module, configured to input the event data corresponding to the to-be-processed image into the optimized PINN model to obtain the luminance values in the logarithmic domain of the three color channels of the to-be-processed image; and
a tone mapping module, configured to use tone mapping to convert the luminance values in the logarithmic domain of the three color channels into the reconstructed image frames.

16. An apparatus of image processing based on an event camera, configured to perform the method of image processing based on the event camera described in claim 5, comprising:
a data obtaining module, configured to obtain the event data corresponding to the blurred image captured by the event camera;
a model construction module, configured to construct the initial PINN model, and embed the event generation equation into the initial PINN model, wherein the input item of the initial PINN model is the event data, and the output item of the initial PINN model is the predicted luminance change-gradient value satisfying the event generation equation;
a model optimization module, configured to input the event data corresponding to the blurred image into the initial PINN model to obtain the predicted luminance change-gradient value of the event data, perform the self-supervised optimization using the temporal derivative loss based on the predicted luminance change-gradient value and the ground-truth luminance change-gradient value, introduce the Tikhonov regularization constraint condition to optimize the initial PINN model, and determine the optimized PINN model in response to the predictive performance of the PINN model meets the predefined standard;
a luminance value prediction module, configured to input the event data corresponding to the to-be-processed image into the optimized PINN model to obtain the luminance values in the logarithmic domain of the three color channels of the to-be-processed image; and
a tone mapping module, configured to use tone mapping to convert the luminance values in the logarithmic domain of the three color channels into the reconstructed image frames.

17. An apparatus of image processing based on an event camera, configured to perform the method of image processing based on the event camera described in claim 6, comprising:
a data obtaining module, configured to obtain the event data corresponding to the blurred image captured by the event camera;
a model construction module, configured to construct the initial PINN model, and embed the event generation equation into the initial PINN model, wherein the input item of the initial PINN model is the event data, and the output item of the initial PINN model is the predicted luminance change-gradient value satisfying the event generation equation;
a model optimization module, configured to input the event data corresponding to the blurred image into the initial PINN model to obtain the predicted luminance change-gradient value of the event data, perform the self-supervised optimization using the temporal derivative loss based on the predicted luminance change-gradient value and the ground-truth luminance change-gradient value, introduce the Tikhonov regularization constraint condition to optimize the initial PINN model, and determine the optimized PINN model in response to the predictive performance of the PINN model meets the predefined standard;
a luminance value prediction module, configured to input the event data corresponding to the to-be-processed image into the optimized PINN model to obtain the luminance values in the logarithmic domain of the three color channels of the to-be-processed image; and
a tone mapping module, configured to use tone mapping to convert the luminance values in the logarithmic domain of the three color channels into the reconstructed image frames.

18. An apparatus of image processing based on an event camera, configured to perform the method of image processing based on the event camera described in claim 7, comprising:
a data obtaining module, configured to obtain the event data corresponding to the blurred image captured by the event camera;
a model construction module, configured to construct the initial PINN model, and embed the event generation equation into the initial PINN model, wherein the input item of the initial PINN model is the event data, and the output item of the initial PINN model is the predicted luminance change-gradient value satisfying the event generation equation;
a model optimization module, configured to input the event data corresponding to the blurred image into the initial PINN model to obtain the predicted luminance change-gradient value of the event data, perform the self-supervised optimization using the temporal derivative loss based on the predicted luminance change-gradient value and the ground-truth luminance change-gradient value, introduce the Tikhonov regularization constraint condition to optimize the initial PINN model, and determine the optimized PINN model in response to the predictive performance of the PINN model meets the predefined standard;
a luminance value prediction module, configured to input the event data corresponding to the to-be-processed image into the optimized PINN model to obtain the luminance values in the logarithmic domain of the three color channels of the to-be-processed image; and
a tone mapping module, configured to use tone mapping to convert the luminance values in the logarithmic domain of the three color channels into the reconstructed image frames.

19. A computer device, comprising a memory, a processor, and a computer program stored in the memory, wherein the processor executes the computer program to perform steps of the method according to claim 1.

20. A non-transitory computer-readable storage medium, wherein the non-transitory computer-readable storage medium stores a computer program, and the computer program, when executed by a processor, performs steps of the method according to claim 1.
